(19) United States
(12) Patent Application Publication
(10) Pub. No.: US 2019/0147541 A1
(43) Pub. Date: May 16, 2019

(54) System and Method to Predict Field Access and the Potential for Prevented Planting Claims for Use by Crop Insurers

(71) Applicant: David P. Groeneveld, Hartford, SD (US)

(72) Inventor: David P. Groeneveld, Hartford, SD (US)

(21) Appl. No.: 16/217,487

(22) Filed: Dec. 12, 2018

Related U.S. Application Data
(63) Continuation-in-part of application No. 14/831,330, filed on Aug. 20, 2015, now abandoned.
(60) Provisional application No. 62/040,146, filed on Aug. 21, 2014.

(51) Int. Cl. G06Q 40/08; G06N 7/00

(52) U.S. Cl. CPC G06Q 40/08; A01C 7/00; G06N 7/005

(57) ABSTRACT

Prevented planting occurs when fields cannot be planted during a time window due to wet conditions—this causes crop losses covered by insurance. Field visits to verify each prevented planting insurance claim seldom can be used to map the loss because fields too wet to plant are also too wet for loss adjusting. PP claims occur in wet years often in magnitudes straining crop loss-adjusting resources and preventing field visits to many claims. Statistical- and physical-based analysis employing weather, topography and satellite-based mapping of historic surface wetness rates the relative probability for PP claims throughout huge geographic regions. The method provides decision support that focuses adjuster attention to claims of low relative probability, possible fraud or unusual circumstances that require on-site documentation and establishes a safe threshold, above which claims can correctly be accepted as valid. The method provides digital documentation for the decision support process.

### CROSS-REFERENCE TO RELATED APPLICATIONS

This application is a continuation-in-part of my co-pending U.S. patent application Ser. No. 14/831,330, filed Aug. 20, 2015, which application claims priority to, and the benefit of, the filing of U.S. Provisional Patent Application Ser. No. 62/040,146, filed Aug. 21, 2014. The specifications of both prior applications are incorporated herein by reference.

### BACKGROUND OF THE INVENTION

### Field of the Invention

The present invention relates generally to the field of spatial technology for crop loss adjusting for the crop insurance industry.

### Background

This application is a continuation-in-part of co-pending U.S. application Ser. No. 14/831,330. The '330 Application is here incorporated by reference in its entirety and provides additional background for the understanding of the present disclosure.

Wet field conditions that prevent a farmer from planting can be indemnified by crop insurance. In temperate climates such as most of the continental United States, planting must be accomplished by a certain date to allow enough time for the crop to yield before growth is curtailed by fall frost—this timing defines a planting window. If the farmer is prevented from planting during the planting window because the field is too wet to enter, the farmer suffers an economic loss. Crop insurance is written specifically to cover such losses, called prevented planting (PP).

When PP occurs, the farmer files a claim for crop insurance compensation. This triggers a visit, required by the U.S. Department of Agriculture's Risk Management Agency (RMA), to the affected field by a crop loss adjuster to confirm that the claim is valid, and the field is too wet to be worked. This visit must happen as soon as possible after the claim is filed and within the planting window, or soon thereafter. If the field is too wet to enter for planting, the field is also too wet to enter for loss adjustment and so, most visits are only initial, to record that the field is wet rather than determining the location and area of the problem. This validation visit is time-critical because fields can dry before visits can be made, especially in relatively wet years when millions of acres can be involved over vast regions.

PP conditions are weather driven frequently cover multistate regions, tens of thousands of claims, and a potential financial consequence totaling well over a billion dollars. Under these conditions, loss adjusting resources are stretched beyond capability and many claims must go unvisited. This situation encourages crop insurance fraud because fraudulent claims cannot be detected from among the huge field of valid claims. Crop insurance fraud is a serious concern for the crop insurance industry and for the federal government that subsidizes and regulates it.

A solution is needed to determine PP claim validity that (1) does not require a visit to each field, while (2) identifying those fields where the claim is questionable and must be visited, through (3) analysis of spatial data that can be readily acquired and applied. Such a program can be accomplished by assessing precipitation received prior to and during the planting period and other spatial properties of each field such as slope that exerts a direct control for field wetness at a given level of antecedent precipitation and a map of a statistical summary of a surrogate measure for wetness derived from an historic record of Earth observation satellite (EOS) data before and during the planting window.

### BRIEF SUMMARY OF THE INVENTION

The invention uses a mathematical analysis of spatial and physical factors that control relative probability (RP) for wet surface conditions conducive for PP claims on fields with PP crop insurance. The invention employs computer algorithms to develop output to be used in decision support for whether to send, or not send, a crop loss adjuster to the field to verify that access is prevented by wet conditions on all or part of the field. Currently, the USDA Risk Management Agency requires all PP claims to be visited to confirm that they are valid.

Initial calculations to develop the decision support tool are performed by rasters of pixel values that are defined across broad areas of interest (AOIs). As used here, an AOI is a large, possibly multistate agricultural region with similar climate and crops. PP claims commonly occur, for example, with North and South Dakota crops, where planting times and general conditions are vastly different from, in contrast, Louisiana and Arkansas. For a particular application of this invention, the precise AOI is to be determined by the Approved Insurance Provider (AIP).

Data input rasters have the same sized pixels, for example one tenth acre, each pixel having normalized departure-from-normal precipitation, normalized topographic slope, and a normalized statistical summary of historic field wetness defined through analysis of multiple images of Earth Observing System (EOS) data (e.g., from satellite imagery). Geographic Information System (GIS) shapefiles of each field define what pixels in the output raster belong to any field. The three data input rasters are combined mathematically to yield a relative probability (RP) index. The values of pixels within any field can be represented as single statistics, for example a median RP index.

The median RP index for all fields within the AOI is ranked from least probable—relatively low scores—to high scores that indicate high probability for PP conditions. Adjusters visit fields with the lowest median RP index scores first, successively working upwards to higher ranked values of RP scores in an operational process that defines a safe threshold, above which all claims prove valid. The method of working upward from low RP scores to identify a safe threshold constitutes a calibration step to be performed each year of operation. Only a fraction of the total PP claims in the AOI need to be visited using this method resulting in savings of money, labor and resources.

Maps can be prepared from the data developed during the preparation of the RP index to serve as decision support documentation for adjuster visits initially, and later for loss adjustment when the field can be entered. These data can serve as the basis for mapping the actual PP-affected area.

### BRIEF DESCRIPTION OF THE DRAWING

The accompanying drawings, which are incorporated into and form a part of the specification, illustrate several embodiments of the present invention and, together with the description, serve to explain the principles of the invention. The drawings are only for the purpose of illustrating a preferred or alternative embodiment of the invention and are not to be construed as limiting the invention. In the drawings:

FIG. 1 depicts a flowchart of a method for preparation of data rasters according to the present disclosure; and

FIG. 2 depicts a flowchart, related sequentially to the chart of FIG. 1, of a method for operations according to the present disclosure.

### DETAILED DESCRIPTION OF ONE EMBODIMENT OF THE PRESENT INVENTION

The method of the invention may be characterized generally by four steps:

Step 1: data assembly for input to the RP index;

Step 2: calculation of the RP index;

Step 3: operational calibration of the RP Index; and

Step 4: decision support and claim documentation.

The four steps are based upon rasters of data pixels across the AOI. The pixels of a field are extracted and parsed per to a file for the field according to the field's boundaries that are defined within GIS shapefiles supplied by the AIP after a claim is filed. The collection of pixels for the field can then be manipulated statistically.

Crop-loss adjusting records can be potentially highly noisy because they must cover many possible variations of conditions, because they are administered and interpreted by individuals, because crop losses are generally not accurately recorded spatially and because there are variable rules for how regulations are interpreted for different crops in different regions—rules that have historically changed from year to year. A simple approach is adopted that bypasses the uncertainty in crop loss claims and records for a method that will work in all regions and that is calibrated operationally.

The invention applies three indisputable measures of wetness spatially, pixel by pixel, in rasters across the AOI. These three input variables—antecedent precipitation, slope, and surface-wetness history assessed from multiple sets of EOS data, provide capability to assist administration of loss adjustment: (1) assessing the relative potential for the conditions that create wet soils. (2) ranking all fields according to this potential. (3) determining thresholds above which all claims are valid and below which all claims must be evaluated further and/or visited, (4) providing the basis for adjusters to determine exactly where PP conditions are likely to occur. (5) providing a definitive basis upon which to discuss with the farmer any field in question and then (6) to map the locations of the PP-induced crop loss.

Numerical analysis provides the means to assign a relative probability for each tenth of an acre in each field based upon physical factors and historical record of wetness as recorded spatially by EOS data. These three datasets perform an acceptable job for separating those claims that are obviously valid from those that are potentially questionable.

### Step 1. Data Assembly for Input to the RP Index

Separate calculations are made to formulate an RP index to represent the promotional effect of historic precipitation, slope that is spatially non-varying, and measurements of historic surface wetness.

Antecedent precipitation is a direct contributor to water on the field. A raster to represent historic antecedent precipitation is constructed with pointwise weather station data across the AOI. These data are first evaluated station-by-station to determine whether data are missing from the required record. If so, weather stations with missing data must be eliminated from the input raster or filled by interpolation from adjacent stations. Once the weather station datasets in the AOI are proofed to be complete, the data are summed for two antecedent periods; for thirty days prior to the update, and for 180 days prior to the update. Antecedent precipitation is then normalized relative to the long-term average for these two periods, such averages prepared in a lookup table with a computer algorithm that pulls the daily precipitation totals that are appropriate for the day of the update. From these totals, a fraction-of-normal precipitation (FNP) index is calculated for each station, spatially-defined by x, easting, and y, northing, in Equation 1 for each period.

$${FNP}_{xy} = \frac{\begin{matrix}Recorded {Precipitation}_{xy} - \\ Average {Precipitation}_{xy}\end{matrix}}{Average {Precipitation}_{xy}} \qquad ( Equation 1 )$$

FNPxy rasters for the 30-day and the 180-day time periods are then developed by interpolation of the xy location of each weather station in the AOI using an algorithm such as inverse distance weighted that is available through open source software. This results in two antecedent-precipitation input rasters sized to 0.1 acre and averaged by addition of the two rasters and division by two resulting in a single raster for input to calculate the RP index. FNPₚ. Raster FNPₚ incorporates the effect from precipitation over the prior 180 days and appropriately weights the result for the more-recent 30-day period since this is common to both datasets. Both rasters are employed because the spatial interpolation for each period is unique and non-linear and would introduce error were pointwise weather station averages for the two periods used to produce a single raster.

The slope of each pixel is determined using digital elevation model (DEM) data. Slope is a direct indicator of the potential for any pixel to drain or to infiltrate and retain precipitation. DEM data are resampled to 0.1 acre and the slope across the pixel is then determined using public domain GIS software that solves for the greatest magnitude slope. Slope effects must be truncated since slopes of 0.1 and greater offer little additional potential for drainage to diminish infiltration to wet the soil; at this slope, drainage is already at a maximum for all agricultural fields. Hence for any slope greater than 0.1, the slope is set to 0.1. The truncated distribution of slope, 0-0.1, is slope′ in Equation 2 for calculation of Inverse Normalized Slope (INS), a slope data input raster, for each pixel p.

INSₚ=α₁(0.1−slope′ₚ)/0.1 (Equation 2)

The value α₁ is a scaling factor to place slope in correct magnitude with precipitation—an acceptable factor for most AOIs is 0.5. Scaling factor α can be determined through multiple iterations of raster calculations for each of the three raster inputs that are used in calculation of inputs to model farmed fields. The target for the calibration is that each of the three raster inputs must be of relatively the same magnitude. Any such iterative scaling must be performed on multiple datasets before operational application in an operation well known to those with ordinary skill.

An historic record of wet conditions measured by EOS data is assembled from shortwave infrared (SWIR) reflectance of the field during the snow-free period prior to, and during the planting window when fields are bare. SWIR reflectance has been shown to be a competent indicator of surface wetness because it is highly absorbed by water. Like slope. SWIR reflectance is inversely proportional to the water content of the surface—for example, values of SWIR reflectance near zero correspond with open water surfaces, while for a given soil, higher values indicate dryer conditions. Equation 3 defines Normalized-SWIR inverse reflectance (NSIR) for an average value for every pixel p in the AOI.

$${NSIR}_{p} = {α}_{2} ( {{β - \sum }^{n}}_{n = 1} ( SWIR {reflectance}_{p} \text{/} n images ) \qquad ( Equation 3 )$$

While SWIR is listed as the input for Equation 3 and will be described throughout this specification, as those with ordinary skill in the art will recognize, another measure of surface wetness is also possible, EOS-based synthetic aperture radar (SAR) data. However. SAR data have not yet been proofed for application to measure surface wetness of fields. Within this specification, it must be understood that the use of SWIR also includes SAR data that can be used instead, or in addition to, SWIR in Equation 3. Useful SAR data can be captured through clouds and may offer timely data acquisition under cloudy spring conditions that often prevent SWIR measurements.

The value β in Equation 3 is an empirically-determined constant for SWIR reflectance on farmed fields of approximately 0.3 to scale the NSIR values as a measure of historic wetness on fields comparable to those generated for FNPₚ and INSₚ rasters in combination with an empirical factor of 2.5. EOS SWIR data are available from the Landsat program for 34 years at a resolution of 30 m, while Sentinel 2 SWIR data are available at 20 m for several years. Both datasets must be resampled into 0.1-acre pixels. Value α₂ is an empirically-determined scaling factor to scale the pixelwise average SWIR reflectance through time represented by Equation 3 to be of comparable numerical distribution to the two other inputs that are combined in Equation 4.

### Step 2. Calculation of the RP Index

The three input raster datasets are combined to form the RP index as defined in Equation 4 for each pixel p.

$$RP {Index}_{p} = \frac{{FNP}_{p} + {INS}_{p} + {NSIR}_{p}}{3} \qquad ( Equation 4 )$$

The RP index produced from Equation 4 is a raster of all pixels in the AOI. The next steps in the workflow brings the analysis down to the individual field that has received a PP claim. Notification from the AIP for the claim to enable this analysis must contain at least a shapefile that locates the field in space. These data are also provided to the crop loss adjuster plus a telephone number to contact the farmer. The shapefile is employed to establish the set of pixels lying within the field.

The set of pixels within the field establish a statistical population to switch from raster-based to pixel-wise statistics. The pixel values of the RP index within the shapefile are extracted and evaluated statistically to determine the median RP value for all pixels for each claim field in the AOI.

### Step 3. Operational Calibration for the RP Index Safe Threshold

Calibration of the RP index against policies and claims is highly desirable but not possible presently because these data are not available in the spatial quality necessary for calibration. Instead, calibration is performed operationally by sequentially visiting PP claims that have the lowest median RP index first, and then working sequentially to claims with higher values. Claims are validated or denied during the field visit and this process is curtailed once a safe threshold is reached, above which, all claims with high RP index values can be considered valid.

Sending adjusters to fields with low median RP index first and working sequentially to fields with higher median RP index will calibrate a score above which all claims can safely be assumed are valid, called the safe threshold. In order to identify a safe threshold, fields with higher median RP index scores must be visited in order to identify a point above which, it is safe to conclude that the claim is valid without a field visit.

To enable working the claims sequentially according to the median RP Index, first pooling the RP index for all claim fields across the AOI and then ranked lowest to highest. Updated running-records of the claim fields visited and the resulting judgement that the claim was valid or denied are maintained for the AOI during the planting window. As data from field visits accumulate, the running record is continually evaluated to determine the highest median RP index for a field that received a denial, this statistic is called the max denial. Fields are visited for 5 percent of the median RP index mathematical distribution above the max denial. The median RP index distribution is the maximum minus the minimum median RP index.

Performing field visits each year according to this workflow will identify a threshold with an adequate additional margin of safety. Adjustment of the safe threshold is made operational each year so that it is appropriate for the conditions present. The safe threshold is likely going to be reduced through time as specious claims are controlled and drop out of the pool used for evaluating claims. The effect of this mechanism will be accommodated by the method of operational calibration Thus, this method can be seen to be simple, easily administered by AIPs, and self-calibrating. The method provides a robust means to safely eliminate an initial visit for the largest proportion of claims that lie above the safe threshold.

### Step 4. Decision Support and Claim Documentation

Once the safe threshold is reached, no further claims need to be considered for a field visit because the remaining claims will be valid, fields will be wet, and crops will not have been planted. The number of claims not visited is expected to be extremely high, in the range of 90% of the total claims in an AOI.

The method for operational calibration through sequential visits, from low to higher median RP index, correctly focuses adjuster attention where it is needed, for those fields that are unusual and have the least likelihood for PP conditions, but the greatest potential for crop fraud. Also, regardless of the threat of fraud, focus on claims with low median RP index values will assure that if unusual circumstances are involved, they are well-documented for compliance and adjusting documentation.

Another benefit to this invention is to develop data to document PP conditions on every field in each AOI whether they have a claim or not. An RP index map and the median RP index can be generated for any field of interest within the AOI by using a shapefile to extract and parse the data. These data can be used in future years to understand patterns of claims and to anticipate the volume of PP claims for both financial and operational purposes.

Ranked fields with low median RP index values indicating a loss-adjuster visit are expected to be a small proportion of the distribution also offering the opportunity to enhance communication between the farmer through an advance telephone call to discuss the circumstances surrounding the claim. Documentation derived by the method can be viewed by both the adjuster and the farmer including maps of the RP index distribution across the field, and if available, recent EOS data—SWIR or SAR. A field visit, thereafter, may only be needed if the farmer's explanation is not plausible or is disputed by the recent EOS data. This documentation is electronic and can be conveniently delivered through internet connectivity. The RP index identifies areas of high relative probability for wet conditions and if wet areas documented through recent EOS data are within zones of low RP index, these may be the result of some unusual problem, for example flooding arising from an adjacent field or a plugged culvert. Both the adjuster and the farmer will be armed with the data to document the problem and potentially avoid an expensive and unnecessary field visit.

All claims, including those visited initially because their median RP index is above safe thresholds, must be visited later for the loss adjustment work to identify those areas that were not planted as the basis for compensation. After employment of the present method, most field visits will for mapping the areas of prevented planting for insurance compensation after the field has dried sufficiently to enable adjuster access. During the adjuster visit, the distribution of the RP index and recent EOS data can guide mapping the actual area of PP loss. EOS data can also be applied to map PP-affected areas on fields as is provided by U.S. Pat. No. 10,062,119 entitled “A System, Method. and Product for Automated Crop Insurance Loss Adjusting for Prevented Planting Conditions” and incorporated by reference, performs automated loss adjusting by mapping the PP locations that are distinguishable because of low plant cover.

Maps of RP index and EOS-measured wetness serve to document reasonable decisions for PP crop loss adjustment. Such documentation is necessary both to demonstrate reasonable loss-adjusting decisions for the farmer and before the RMA. In their role for monitoring and regulating the crop insurance industry, the RMA regularly performs program overview that checks for the conformance in loss adjustment and these data will provide supporting documentation.

### DETAILED WORKFLOW DESCRIPTION

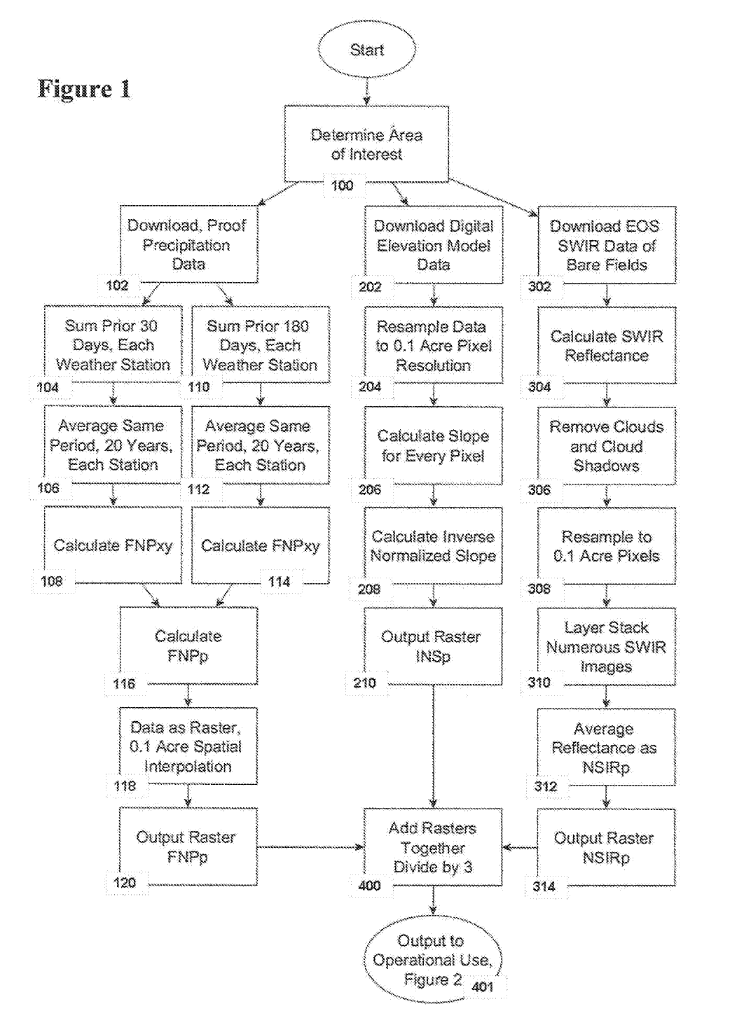

Reference is invited to FIG. 1, which presents a flowchart for data preparation. The AOI is defined at 100 to start the workflow. Passing to 102, daily precipitation within the AOI for the previous 20 years is downloaded and checked for missing records. If data are missing, the station is discarded from the analysis or the data infilled by inverse distance weighted interpolation from adjacent stations. The precipitation is summed across two antecedent time periods, the prior 30 days, at 104, and the prior 180 days, at 110. These same periods are summed, and averages calculated for 20 years of record for each station at 106 and 112. New analyses update the output at least weekly, and the 30 day and 180 antecedent periods change according to the date of the update. These refinements are not called out explicitly in FIG. 1.

At steps 108 and 114 of FIG. 1, the statistics for FNPxy are calculated according to Equation 1. These results then pass to step 116 where an average of the two FNPxy values is calculated. Until step 118, the data are dealt with as statistics. At step 118 and throughout other portions of this flowchart, the data are rasters, beginning with pointwise average FNPxy values for each weather stations that are rasterized according to their xy geo-locations, and interpolated at 118 to a resolution of 0.1 acre using GIS software and inverse distance weighted algorithm to yield FNPₚ called out at step 120 passing to 400 for combination with the other two input rasters. All such calculations are performed by computer in steps well known to those with ordinary skill in the art.

Returning to step 100 of FIG. 1, the workflow methodology passes to 202 where digital elevation model data for the AOI are downloaded and resampled to 0.1-acre resolution at 204 through spatial averaging. Slope across every pixel is calculated at 206 using public domain software, a step known to persons having ordinary skill in the art. At step 208, slope across every pixel is used to calculate inverse normalized slope for every pixel, as described by Equation 2. These raster data pass to step 210 for output to 400. These steps are performed using public domain software and calculations that are well known to persons with ordinary skill in the art.

Returning again to step 100, the workflow of the method passes to 302 where EOS data within the AOI that contain at least the SWIR band are downloaded for bare fields from archives of from several years to over 30 years depending upon the EOS platform. Agricultural fields are typically bare prior to and during the planting window and from a month or more prior to planting for row crops in most areas of the United States. At step 304, SWIR reflectance is calculated and at 306 clouds and cloud shadows are removed using algorithms well known to those with ordinary skill in the art. At 308, these rasters are resampled to 0.1-acre pixels and are layer stacked at step 310, a term of art for geocorrect northing and easting represented as layers, while the time dimension is a stack of layers, each representing an image date. NSIR, as described in Equation 3 is calculated at 312 for each pixel in the raster, passing to raster output at 314 that passes to step 400.

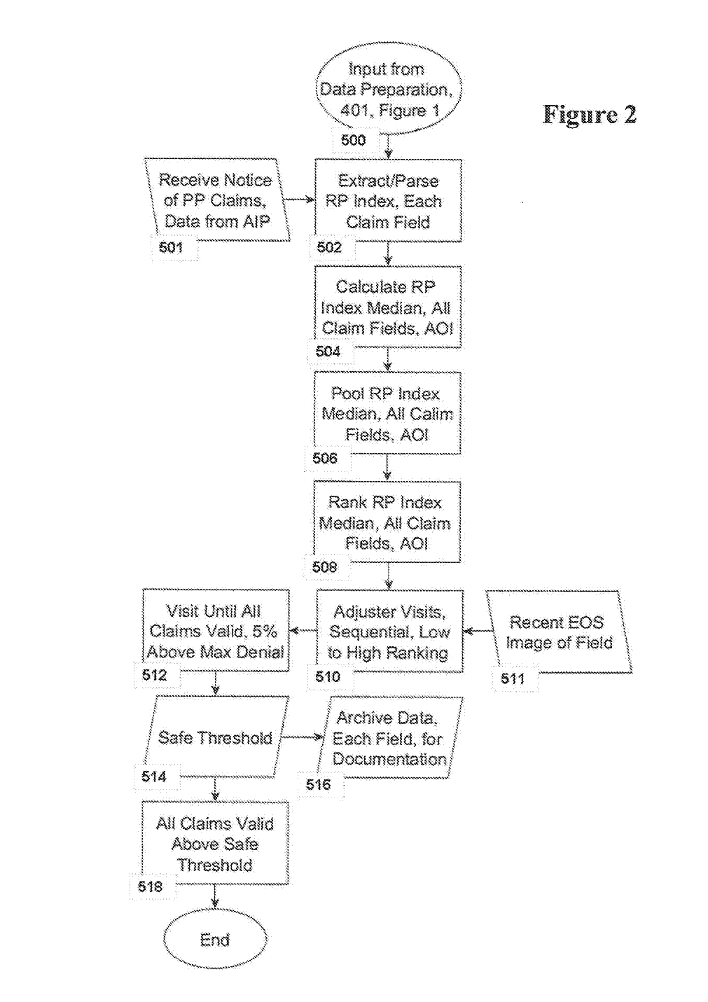

At the step 400 illustrated in FIG. 1, the three rasters from process steps 120, 210 and 310 are averaged to yield a third raster, a mathematical representation of the relative probability for wet conditions on each pixel, the RP index (Equation 4), which is output for operational use at step 401. The output from step 401 is then usable into step 500 of FIG. 2.

Station 500 of FIG. 2 is receiving data output at 401 of FIG. 1 for operational use. Except for the weather stations downloads, all calculations in FIG. 1 were for rasters. All further calculations illustrated in FIG. 2 are as statistics, not rasters—a change that begins with the receipt of PP claim information from the AIP at step 501 that includes a GIS shapefile for each claim field. At step 502 of FIG. 2, shapefiles are used to extract the RP index data and parse these data to files for each field. The median RP index is calculated for all claim fields at 504 that are pooled for the AOI at 506. Each claim field is ranked from the AOI pool. Decision support for loss adjusting begins at 510 by adjuster visits at the low end of the median RP index ranking, working up in ranking for sequential field visits. If a recent EOS image of the field is available of SWIR or equivalent SAR data, these are supplied to the adjuster, at step 511, for assistance in documentation and discussion concerning the claim field with the farmer.

Sequential visits continue until the max denial is hit for an additional 5° % of the distribution at step 512. After the safety 5% margin, if no further denials occurred for the claim fields, the safe threshold has been reached at block 514. All data and maps developed for the loss adjusting of each field are archived at 616. Median RP index values above the safe threshold are deemed valid at 518, no further claims need be visited, and the flowchart ends.

If the query at method step 618 passes to 628 where one of the two safe thresholds is exceeded in either regions “c” or “d,” this condition is unexpected, and the adjuster must communicate by telephone to determine the circumstances for the PP claim with the farmer. Telephone numbers are part of the data for every loss claim and it is typically mandatory that the adjuster contact the farmer before paying a visit to the field of interest. The query at 632 asks whether the explanation given by the farmer was valid, meaning both plausible and likely under the circumstances. A “yes” response passes to 624 to assist setting the safe threshold for use in the following year and a no response passes to 622 for a field visit.

Although the invention has been described in detail with particular reference to these preferred embodiments, other embodiments can achieve the same results. The present inventive method can be practiced by employing generally conventional materials and equipment, including commercially available computer hardware and central processing units. Accordingly, the details of such materials and equipment are not set forth herein in detail. In this description, specific details are set forth, such as specific structures, processes, etc., in order to provide a thorough understanding of the present invention. However, as one having ordinary skill in the art would recognize, the present invention can be practiced without resorting strictly only to the details specifically set forth. In other instances, well known processing structures have not been described in detail, in order not to unnecessarily obscure the present invention.

Only some embodiments of the method of this invention and but a few examples of its versatility are described in the present disclosure. It is understood that the invention is capable of use in various other combinations and is capable of changes or modifications within the scope of the inventive concept as expressed herein. Modifications of the invention will be obvious to those skilled in the art and it is intended to cover in the appended claims all such modifications and equivalents.

I claim:

1: A method employing a computer and software steps to assess a relative probability for wet conditions during a planting window that prevent access to a plurality of claim fields, located within an area of interest, causing a crop to not be planted and causing a plurality of prevented planting claims that are indemnified under at least one crop insurance policy, upon receiving notification from the crop insurance company of a prevented planting claim on a first claim field, so to assess the relative probability for wet conditions on the first claim field through calculation of a relative probability index, to rank the relative probability index in comparison of the first claim field to all other fields of the plurality of fields within the area of interest, thereby establishing a relative probability index distribution upon which to base a decision to send a crop loss adjuster to visit and validate or deny the prevented planting claim on the first claim field based upon visible wet field conditions, visiting in sequence others of the plurality of claim fields starting with claim fields, a lowest relative probability ranking and working upward in relative probability ranking to a value point 5% above the highest relative probability index value for a denied field whose claim is denied from the crop loss adjuster visit, thereby establishing a safe threshold value above which all prevented planting claims can be accepted as valid without field validation, the method further comprising:
collecting and preparing a multitude of data into a multitude of data input rasters at the same scale;
combining the data input rasters using raster mathematics to calculate a raster of the relative probability index to enable estimation of the relative probability for prevented planting conditions for a multitude of pixels across the area of interest;
receiving digital notification of the plurality of prevented planting claims from an approved insurance provider, the notification comprising at least a digital GIS shapefile for each field of the plurality of claim fields;
employing a computer to parse a statistical population of the relative probability index for the pixels on each field of the plurality of claim fields, and using the digital GIS shapefile to identify a statistical population of pixels located within boundaries of the digital shapefile;
for each field of a statistical population of the plurality of claim fields with prevented planting claims, calculating summary statistics of the statistical population of pixels;
combining the summary statistics for each field of the plurality of claim fields within the area of interest and calculating a relative probability ranking for each field based upon at least one summery statistic of relative probability for prevented planting conditions on a particular field;
using the probability ranking of each field to determine whether the particular field should receive a field visit;
sending the crop loss adjuster to claim fields according to the relative probability ranking for each field, starting at a field with a lowest probability ranking and working upward through the plurality of fields with prevented planting claims in order of increasing relative probability rankings;
performing an operational calibration by visiting claim fields according to relative probability ranking sequentially from lowest ranking to higher ranking and by noting a last fail point that is a highest probability ranking for a prevented planting claim which has proven invalid through a particular field visit;
visiting claim fields having probability rankings above the last fail point and up to the safe threshold value;
adjusting the safe threshold value downward in subsequent years within the area of interest;
storing to a plurality of files the relative probability raster and developed data, notes and photographs, each file representing an individual claim field;
creating for decision support a multitude of maps and summaries from the developed data, notes and photographs;
parsing the multitude of maps and summaries to the file representing a particular individual claim field; and
storing the safe threshold value from a current year for the area of interest for use the next year.

2: The method of claim 1 wherein the multitude of data input rasters includes a raster of precipitation antecedent to an update of precipitation data during or before the planting window.

3: The method of claim 2 wherein the raster of antecedent precipitation is calculated from a summation of daily precipitation for at least one of a plurality of weather stations over a time period prior to the update.

4: The method of claim 2 further comprising calculating, from a plurality of years prior to the update, a long-term average precipitation.

5: The method of claim 4 wherein the precipitation antecedent to the update is divided by the long-term average precipitation to yield a fraction of normal precipitation.

6: The method of claim 3 wherein the plurality of weather stations has a location datum within the area of interest.

7: The method of claim 2 further comprising performing a spatial interpolation for all pixels in the raster of antecedent precipitation.

8: The method of claim 1 wherein the multitude of data input rasters includes a digital elevation model for the area of interest.

9: The method of claim 8 wherein a maximum slope across each pixel in the area of interest is calculated with a public domain software algorithm to yield a maximum slope data input raster.

10: The method of claim 1 wherein the multitude of data input rasters includes a raster map of average historic wetness on any particular field measured by a plurality of Earth observation satellite images.

11: The method of claim 10 wherein the multitude of Earth observation satellite images are the reflectance across the area of interest, measured within a region of water absorption in a shortwave infrared portion of the electromagnetic spectrum.

12: The method of claim 10 wherein the raster map of average historic wetness contains an average reflectance magnitude for each pixel calculated from the plurality of Earth observation satellite images.

13: The method of claim 1 in which the multitude of data input rasters includes at least three input rasters: precipitation antecedent to an update input raster, a maximum slope data input raster, and a raster of historic wetness.

14: The method of claim 13 further comprising using an adjustment factor for each of the data input rasters for antecedent precipitation, for maximum slope, and for historic wetness to scale these input rasters to have substantially equivalent magnitude.

15: The method of claim 13 wherein each of the at least three data input rasters is adjusted mathematically to increment from low to high relative probability for wetness.

16: The method of claim 13 wherein the at least three data input rasters are added together and divided by three to yield a relative probability index.

17: The method of claim 1 further comprising using the digital shapefile to extract the relative probability index values for the pixels within a particular claim field.

18: The method of claim 1 further comprising calculating a median relative probability index for a particular claim field from the multitude of relative probability index pixel values for the claim field.

19: The method of claim 1 further comprising pooling the relative probability index values together for the area of interest

20: The method of claim 1 further comprising ranking the relative probability index values lowest to highest across the area of interest.

21: The method of claim 1 further comprising validating or denying a claim.

22: The method of claim 1 further comprising storing results from a particular claim field visit with the relative probability ranking for the particular field for comparing of valid and denied claims and their respective numerical ranking

23: The method of claim 1 wherein when the safe threshold is reached, no further claim fields are visited.

24: The method of claim 23 further comprising visiting 5% of the relative probability index distribution above the highest relative probability index value that was denied after field visit.

25: The method of claim 1 further comprising storing data from determination of the relative probability index, including at least two rasters of relative probability index and raster of historic wetness on the particular field, for reference during the field visit and for use during a next planting window for the area of interest.
